(19) United States
(12) Patent Application Publication
(10) Pub. No.: US 2026/0235207 A1
(43) Pub. Date: Aug. 13, 2026

(54) Lubricant Pumping Seal

(71) Applicant: System Seals, Inc., Cleveland, OH (US)

(72) Inventors: Arnold von Engelbrechten, Cleveland Heights, OH (US); Ronald Claus, Medina, OH (US); Kurt Sassmannshausen, Brecksville, OH (US)

(73) Assignee: System Seals, Inc., Cleveland, OH (US)

(21) Appl. No.: 19/157,686

(22) PCT Filed: Feb. 21, 2024
(86) PCT No.: PCT/US2024/016774

§ 371 Date: Aug. 18, 2025

Related U.S. Application Data
(60) Provisional application No. 63/447,335, filed on Feb. 21, 2023.

(51) Int. Cl. F16J 15/3232; F16J 15/324; F16J 15/3272

(52) U.S. Cl. CPC F16J 15/3232; F16J 15/324; F16J 15/3272

(57) ABSTRACT

A seal includes an annular body including an outer circumferential surface, an inner circumferential surface defining a central opening about a seal axis, an inner axial face, and an outer axial face. The seal includes at least one continuous, uninterrupted, flexible helically extending sealing lip with an inner edge that is axially offset in a first axial direction relative to the outer edge of the helically extending sealing lip. The seal can include an optional circular lip. The seal can include a pressure relief valve. The seal can be split and can include a seal retainer located in a slot to retain first and second split faces abutted. The seal can be installed in a housing of a wind turbine with shaft of the wind turbine extending through the central opening of the seal body such that the sealing lip is engaged with an outer surface of the shaft.

### CROSS-REFERENCE TO RELATED APPLICATION

This application claims priority from and benefit of the filing date of U.S. provisional application Ser. No. 63/447,335 filed Feb. 21, 2023, the entire disclosure of which is hereby expressly incorporated by reference into the present application.

### BACKGROUND

A wide variety of seals are well-known and in widespread use for engaging a rotating shaft to inhibit leakage or escape of a lubricant such as oil or grease with respect to a bearing or other sealed internal region of a housing to which the seal is operatively connected. One such application for such seals is sealing the bearings of the input shaft of a wind turbine which is rotated by wind power.

Known seals for wind turbines and similar applications have been found to be suboptimal for different reasons. As wind turbines continue to increase in size, the correspondingly larger bearings exhibit greater radial and axial deflections which can cause the rotating shaft to become misaligned with respect to the seal. Known seals such as single or multiple circular lip seals are sometimes unable to accommodate the shaft deflection while maintaining an effective seal against the outer surface of the shaft which can allow contaminates to move past the seal into the bearing and which can also allow the grease or oil lubricant to escape the bearing. Leakage of lubricant is more pronounced when oil rather than grease is used the lubricant due to the fact that the oil is less viscous than grease and tends to flow outwardly toward and escape past the seal. With a circular lip seal, once the lubricant moves out of the bearing region past the seal lip, the lubricant cannot be recovered by the seal, so the bearing lubricant must be replenished during a maintenance procedure.

Known seals with one or more circular sealing lips are also problematic with respect to their replacement in the field. For wind turbines and many other applications, it is necessary to split a replacement seal to install the replacement seal around a shaft. When the new seal is coaxially positioned about the shaft, the opposite ends of the split must be repaired/reconnected by adhesive, vulcanization, or other bonding means/methods. Any misalignment during the split repair/closing procedure will result in a defective sealing lip that will leak at the locations where the split ends of the lip are connected together.

It is also known the provide a seal for the rotating shaft of a wind turbine or another application wherein the seal includes one or more helical sealing lips that induce movement of or “pump” the lubricant inwardly toward the bearing as the shaft rotates relative to the helical sealing lip(s) of the seal. However, the one or more helical sealing lips of such known seals have been structured such that the sealing lip is curved outward relative to the housing, away from the bearing when installed, i.e., such that a radially outer portion of the sealing lip that is connected to the seal body is located axially inward (closer to the bearing) with respect to a radially inner portion of the sealing lip that is in contact with the rotating shaft. Those of ordinary skill in the art will recognize that, with such a structure and arrangement, any pressure exerted by the lubricant on the sealing lips from the inner (bearing) side will tend to lift the sealing lip off of the shaft outer surface allowing the lubricant to flow outward between the sealing lip and the shaft and escape the bearing housing, which is highly undesirable for the reasons noted above. With a helical sealing lip, when the shaft is rotating in a first or forward operative direction, such as when the wind turbine is operative to generate power, the lubricant is continuously pumped inwardly toward the bearing with inhibits leakage of the lubricant. However, when the shaft is rotated in a second or reverse direction, opposite the first operative forward direction as can occur when the wind turbine is back-driven by wind, the pumping action of the helical sealing lip(s) works in reverse and urges the lubricant outwardly away from the bearing which undesirably increases the outward pressure that the lubricant exerts on the sealing lip(s) and causes the sealing lip(s) to unseat from the shaft as noted above which allows the escape of lubricant. When oil is used as the lubricant, the problem is exacerbated due to the lower viscosity of oil as compared to grease which allows the oil to flow axially outward into and fill the sealing lip(s) which further increases the outward leakage pressure when the shaft rotates in the second (reverse) direction.

### SUMMARY

In accordance with one aspect of the present development, a seal includes an annular body including an outer circumferential surface that defines an outside diameter, an inner circumferential surface that defines a central opening about a seal axis, an inner axial face, and an outer axial face, wherein said inner and outer axial faces extend between the inner and outer circumferential surfaces on inner and outer axial sides of the annular body. The seal also includes at least one continuous, uninterrupted, flexible helically extending sealing lip with opposite first and second ends and including an outer edge connected to the inner circumferential surface of the body and an inner edge spaced inwardly toward the seal axis relative to the outer edge, wherein the inner edge of the helically extending sealing lip is axially offset in a first axial direction as compared to the outer edge of the helically extending sealing lip.

In accordance with another aspect of the present development, a seal includes an annular body with an outer circumferential surface that defines an outside diameter, an inner circumferential surface that defines a central opening about a seal axis, an inner axial face, and an outer axial face, wherein the inner and outer axial faces extend between the inner and outer circumferential surfaces on inner and outer axial sides of the annular body. The seal includes at least one continuous, uninterrupted, flexible helically extending sealing lip including opposite first and second ends. The seal includes a pressure relief valve connected to the body and selectively communicating lubricating oil from a chamber located adjacent the second end of the helically extending sealing lip to a region adjacent the first end of the helically extending sealing lip.

In accordance with a further aspect of the present development, a seal includes an annular body including an outer circumferential surface that defines an outside diameter, an inner circumferential surface that defines a central opening about a seal axis, an inner axial face, and an outer axial face, wherein said inner and outer axial faces extend between the inner and outer circumferential surfaces on inner and outer axial sides of the annular body. At least one sealing lip is connected to the inner circumferential surface of the body. The seal body includes an axial split that extends between and through the inner and outer axial faces and that extends between and through the inner and outer circumferential surfaces, wherein said split comprises first and second split faces that are abutted. A seal retainer slot is formed in the body of the seal and circumferentially spans the axial split. A seal retainer is selectively located in the seal retainer slot to retain the first and second split faces abutted with each other.

### BRIEF DESCRIPTION OF THE DRAWINGS

FIG. 1 is a partial cross-section view of a housing, such as a nacelle of a wind turbine, including a lubricant pumping seal provided in accordance with a first variation of the present development.

FIG. 2 is a front view of the lubricant pumping seal of FIG. 1.

FIG. 3 is a rear view of the lubricant pumping seal of FIG. 1.

FIG. 4 is a section view of the lubricant pumping seal taken at line 4-4 of FIG. 2.

FIG. 5 is an enlarged partial section view similar to FIG. 1 (omitting the optional pressure relief valves V), wherein the shaft is partially illustrated and partially broken away to show a sealing lip of the seal in a free state.

FIG. 6 shows a lubricant pumping seal provided in accordance with another variation that is identical to the seal of FIGS. 1-5 but comprises two or more helical sealing lips (such as the illustrated first, second, and third nested helical sealing lips) instead of a single helical sealing lip.

FIG. 7 is an enlarged portion of FIG. 1 that illustrates flow of oil or another flowable lubricant during use of the seal.

FIG. 8 is similar to FIG. 7 but shows another variation of the lubricant pumping seal including an alternative valve design.

FIG. 9 is an isometric view of another variation of a lubricant pumping seal according to the present development that omits the circular sealing lip and can include or omit an optional relief valve.

FIG. 10 is section view taken at cutting line 10-10 of FIG. 9.

FIG. 11 is a partial isometric view of another variation of a lubricant pumping seal provided in accordance with the present development including a reclosable split structure in accordance with one aspect of the present development;

FIG. 12 is similar to FIG. 11 but shows the split retainer in an exploded configuration relative to the seal body.

FIG. 13 is an isometric view of the split retainer.

FIG. 14A is an isometric view of a first split end of the split seal of FIG. 11.

FIG. 14B is an isometric view of a second split end of the split seal of FIG. 11 that is adapted to mate with the first split end of FIG. 14A to close the split structure of the seal for operative use of the seal.

FIG. 15A is a partial exploded front view of the first and second split ends and the split retainer.

FIG. 15B is similar to FIG. 15A but shows an opposite rear view of the first and second split ends and the split retainer.

FIG. 16 shows a split lubricant pumping seal provided in accordance with another variation of the present development including multiple (more than one) split retainer to reclose the split structure for operative use of the seal.

### DETAILED DESCRIPTION OF THE PRESENT DEVELOPMENT

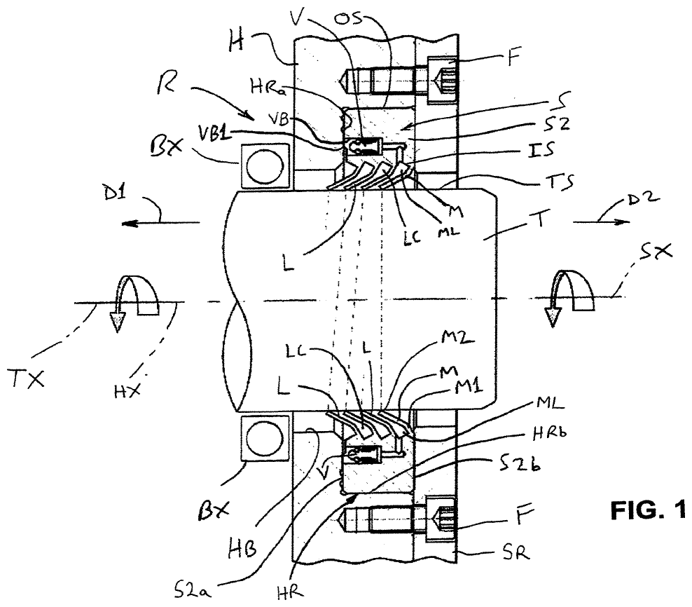

With initial reference to FIGS. 1-3, the present development relates to an annular seal S adapted to be engaged with a rotating shaft T to inhibit ingress of liquid and particulate contamination with respect to a bearing or bearing assembly BX located in a sealed internal region R of a housing H, and to actively pump grease, oil or other lubricant in an axially inward direction D1 with respect to the axis of rotation TX of the rotating shaft T toward the bearing BX or other internal region R of the housing H. The housing H includes a bore HB that extends along a bore axis HX and in which the shaft T is coaxially rotatably supported by the bearing assembly BX. The housing H and shaft T are relatively rotatable, i.e., the housing H can rotate relative to the shaft T and/or the shaft T can rotate relative to the housing H. The housing H can be a nacelle of a wind turbine that generates electricity in response to wind-induced rotation. In one example, the housing H and shaft T are part of a wind turbine and the blades of the turbine are connected to the shaft T such that the shaft T rotates with the blades in a first or operative rotational direction about the axis of rotation TX under wind power relative to the housing H. In another example, the housing H and shaft T are part of a wind turbine, and the blades of the turbine are connected to the housing H such that the housing H rotates with the blades about the axis of rotation TX in a first or operative rotational direction under wind power relative to the shaft T. As noted, under certain conditions, the shaft T can rotate in a second rotational direction that is opposite the first rotational direction if back-driven by wind or for other reasons. The shaft T includes a cylindrical outer surface TS that is sealingly engaged by the seal S.

The seal S comprises an annular body S2 defined from a polymeric material such as polyurethane, polyethylene, polytetrafluoroethylene (PTFE) or any other suitable flexible resilient plastic or elastomeric or polymeric material. The seal body S2 can comprise a continuous, uninterrupted annular or circular ring of any desired cross-section. The seal body S2 can be cast, molded, machined, 3-D printed and/or otherwise additively manufactured, and/or otherwise formed and shaped, and can be a one-piece structure or a multi-piece structure. The seal body S2 includes an inner axial face S2a and an opposite outer axial face S2b. The inner and outer axial faces S2a, S2b typically comprise respective planar faces that are oriented outwardly away from each other and that are arranged so as to be parallel and spaced-apart with respect to each other. The inner and outer axial faces S2a, S2b can each optionally include ribs, grooves and/or other structures as required or desired to facilitate sealing, venting, manufacturing of the seal body S2, or other purposes.

The seal body S2 includes an outer peripheral wall or surface OS that can comprise a circumferentially extending, uninterrupted 360-degree cylindrical surface that defines an outside diameter of the seal S and seal body S2. The seal body S2 also includes an inner wall or surface IS that is located radially inward from the outer surface OS and that also can extend circumferentially and uninterrupted for 360-degrees such that the inner surface IS defines a maximum inside diameter of the seal S and body S2. The inner surface IS defines a central seal opening S4 through which the associated shaft T extends. The inner and outer axial seal faces S2a, S2b connect and extend between the inner and outer surfaces IS, OS of the body S2. The seal opening S4 extends axially between the inner and outer faces S2a, S2b of the seal body S2 and defines an axial length equal to the axial distance measured between the inner and outer seal faces S2a, S2b along an axis arranged parallel to a central longitudinal axis SX of the seal body S2. The seal opening S4 is coaxially defined about the seal axis SX.

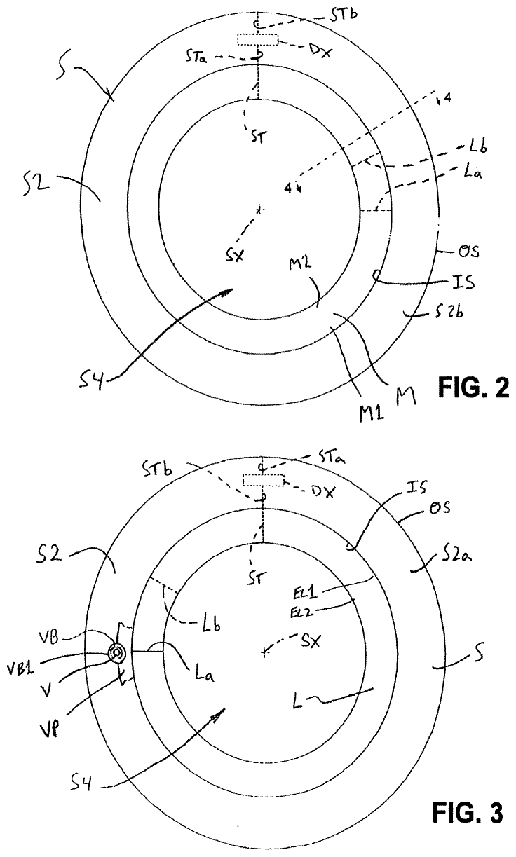

The seal body S2 can optionally include an axially extending split ST (see FIGS. 2 & 3) that extends axially completely between the inner and outer faces S2a, S2b and also extends radially completely between the inner and outer circumferentially extending surfaces IS, OS so that the seal body S2 can be selectively manually spread apart, installed about the shaft T, and the opposite first and second faces STa, STb of the split ST re-closed with or without the aid of one or more dowels or other alignment studs DX or structure inserted into and/or defined as part of the abutted faces STa, STb so that the seal body S2 once again defines an operative annular shape with uninterrupted inner and outer circumferential surfaces IS, OS.

Referring again specifically to FIG. 1, the housing H also includes a seal installation cup or recess HR that is typically a cylindrical recess that coaxially surrounds the housing bore HB and in which the annular seal S is received and seated, with the seal inner face S2a abutted with an inner/bottom wall HRa of the recess HR and with the seal outer cylindrical surface OS closely surrounded by a peripheral wall HRb of the recess HR to coaxially align the seal axis SX with the shaft axis TX and a central axis HX of the housing bore HB. A seal retainer SR is fixedly secured to the housing H adjacent and/or in abutment with the seal outer face S2b using fasteners F or another selectively releasable connection or engagement to capture and retain the seal S in the seal installation recess HR in its operative position such that the seal S is coaxially positioned relative to the housing bore axis HX. The seal body S2 engages the housing H in a fluid-tight manner.

The seal body S2 is annular such that the seal body S2 includes or defines the central seal opening S4 that is circularly defined about a central axis SX of the seal body S2. The shaft T extends coaxially through the seal opening S4 such that the seal body S2 coaxially surrounds the shaft T and so that the axis of rotation TX of the shaft T and the central axis SX of the seal body S2 (and seal opening S4) are coincident.

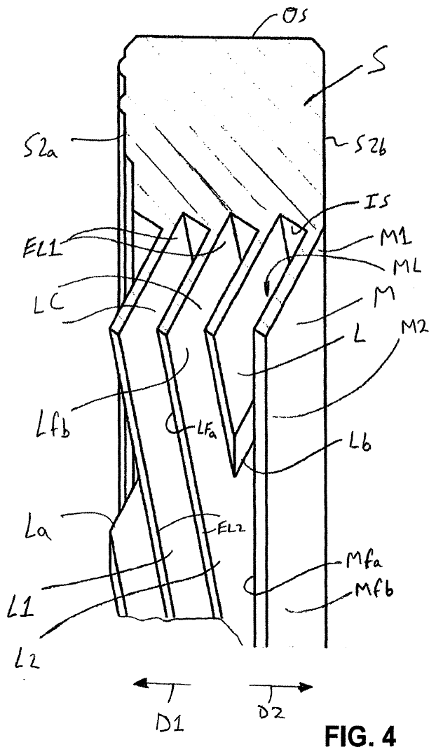

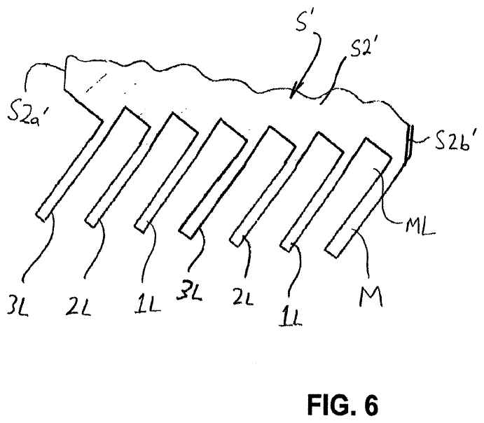

FIG. 2 provides a front (outer) side view of the seal S of FIG. 1, FIG. 2 provides a rear (inner) side view of the seal S of FIG. 1, and FIG. 4 provides a section view taken at line 4-4 of FIG. 2. Referring to all of FIGS. 1-4, the seal S further comprises at least one helically extending flexible sealing lip L connected to the inner surface IS of the seal body S2 and projecting radially inward from the inner surface IS into the seal opening S4. Only a single sealing lip L is shown in the illustrated example, but more than one helical sealing lip L can be included with the multiple lips L arranged in a nested helical arrangement as described below with reference to FIG. 6. The sealing lip L or each sealing lip L extends continuously and uninterrupted in a helical path along the inner surface IS between a first or inner end La of the lip L and an opposite second or outer end Lb of the lip L. As such, between its opposite first and second ends La, Lb, the sealing lip L includes or defines at least one and as shown herein at least two complete helical turns L1,L2 around and centered on the seal axis SX. The lip L thus comprises a continuous, uninterrupted flexible strip of polymeric material that can be formed as one-piece with the seal body S2 and that can include a radially outer edge EL1 (FIGS. 3 & 4) that is connected to the inner surface IS. The lip L can further comprise a radially inner edge EL2 (FIGS. 3 & 4) that is spaced radially inward from the lip outer edge EL1 and that is also offset axially from the lip outer edge EL1 in the first direction D1, i.e., the lip outer edge EL1 is axially closer to the outer face S2b of the seal body as compared to the lip inner edge EL2. The lip inner edge EL2 is adapted and configured to sealingly engage the outer surface TS of the shaft T.

The lip L (or each lip L if more than one lip is provided) includes a central portion or body between its outer and inner edges EL1,EL2 and also includes opposite inner and outer axial faces LFa, LFb (FIGS. 4 & 5). The lip inner and outer axial faces LFa, LFb are oriented toward the seal body inner and outer axial faces S2a, S2b, respectively. The lip L can have any desired cross-sectional thickness measured between its inner and outer faces LFa, LFb including a variable thickness that increases and/or decreases or otherwise changes as the lip L extends away from the inner surface IS toward its inner edge EL2, provided that at least the inner edge EL2 of the lip L is resiliently flexible. The illustrated embodiment the seal S includes a single lip L. In an alternative embodiment, the seal S includes two, three or more multiple nested helical lips L with the respective inner and outer opposite ends La, Lb thereof circumferentially offset with respect to each other but with the lips otherwise similarly or identically conformed and dimensioned. FIG. 6 shows a seal embodiment S′ that is otherwise identical to the seal S but comprises a body S2′ including two or more helical sealing lips L including first, second, and third axially offset, nested helical sealing lips L (1L,2L,3L).

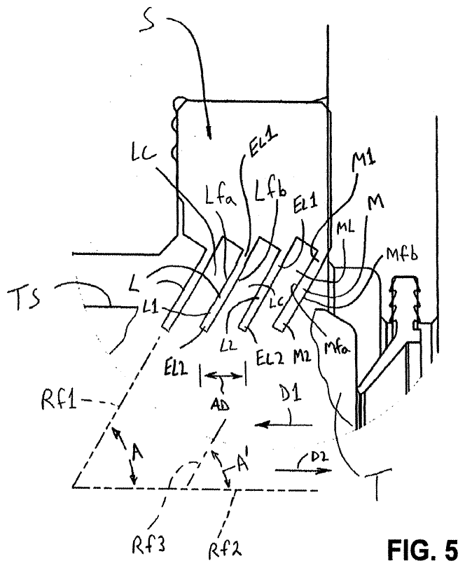

In FIG. 5, the shaft T is only partially illustrated with a portion of the shaft T broken away to show the seal S and sealing lip L thereof in a free state, i.e., not operatively engaged with the shaft outer surface TS. The seal S is structured such that when the lip L of the seal S is in an undisturbed or free state and not engaged with the outer surface TS of a shaft T, the helical lip L is angled or biased in an inward axial direction toward the seal inner face S2a (toward the bearing BX and inner region R of the housing H of FIG. 1) and away from the seal outer face S2b such that for any circumferential location on the sealing lip L, the inner edge EL2 of the sealing lip L is shifted axially inward and located farther away from the seal outer face S2b as compared to the outer edge EL1 of the sealing lip L. In particular, the lip L extends into the seal bore S4 from its outer edge EL1 in both a radially inward direction toward the seal axis SX and also in a the first axially inward direction D1 such that an acute offset angle A is defined between a first reference line Rf1 that intersects or includes the outer and inner edges EL1,EL2 of the lip L and a second reference line Rf2 that is coplanar with the first reference line RF1 and also coincident with or parallel with the seal axis SX. The acute offset angle A is less than 90 degrees and, for example, can be less than 70 degrees or can be 60 degrees or less. In one non-limiting example, the acute offset angle A lies in the range of 65 degrees to 35 degrees, inclusive, or in the range of 60 degrees to 40 degrees, inclusive, such as 60 degrees or 55 degrees or 50 degrees, for example. Due to this offset angle A, the inner edge EL2 of the sealing lip L can protrude axially from the seal bore S4 beyond the seal inner face S2a in certain embodiments. On the other hand, since the outer edge EL1 of the lip L is connected to the inner surface IS of the body S2, this outer edge EL1 of the lip L is connected to the inner surface IS between the inner and outer seal faces S2a, S2b.

The outer edge EL1 of the lip L extends along the cylindrical inner bore surface IS in a helical path or spiral path centered at the longitudinal seal axis SX such that the inner edge EL2 and the entire lip L, itself, also extends along a helical or spiral path about the longitudinal seal axis SX and such that the inner edge EL2 of the lip L also follows a helical path centered on the longitudinal seal axis SX. Due to the acute offset angle A that is less than 90 degrees, for any circumferential location on the sealing lip L, an axial offset distance AD (FIG. 5) is defined between the respective axial locations of the outer and inner edges EL1,EL2. In one embodiment, the lip L extends around the longitudinal seal SX axis at least one (1.0) complete (360-degree) helical turn and preferably at least one-and-one-half (1.5) complete helical turns, such as at least as two (2.0) or three (3.0) complete helical turns, but more than three complete helical turns can alternatively be provided by the sealing lip L.

As the lip L extends helically between its opposite first (inner) and second (outer) axial ends La, Lb, the lip L preferably defines or includes a constant lip height as defined between its outer and inner edges El1,EL2 such that the lip inner edge EL2 defines a cylinder having an inside diameter defined between the inner lip edge EL2. The associated shaft T to be sealed must have an outside diameter greater than this inside diameter defined by the inner edge EL2 of the sealing lip(s) L for the lip inner edge EL2 to engage the outer surface TS of the shaft T for seal S to operate as described herein.

Between axially successive turns L1,L2 of the sealing lip L, an open, helically extending lubricant channel LC is defined and extends continuously and uninterrupted along a helical path centered on the longitudinal seal axis SX between the first and second opposite axial ends La, Lb of the sealing lip L. The lubricant channel LC is bounded or closed on its opposite axial sides by the axial faces LFa, LFb of the lip L (i.e., by axially successive portions or turns L1,L2 of the lip L), and is bounded or closed at its radially outermost end by the inner surface IS. The lubricant channel LC is open on its radially innermost end or region and opens into the seal opening S4 when the seal S is not operatively engaged with an associated shaft T. When the seal S is operatively engaged with the outer surface TS of the shaft T, the lubricant channel LC is closed at its radially innermost end by the shaft outer surface TS as shown in FIG. 1.

In the embodiment of FIGS. 1-5, the seal S also includes an outer endless circular sealing lip M located adjacent the outer end Lb of the helical sealing lip L, between the outer end Lb of the helical lip L and the outer axial face S2b of the seal body S2. The circular sealing lip M extends for a single 360-degree continuous and uninterrupted turn around and centered on the seal axis SX. The circular sealing lip includes opposite inner and outer axial faces Mfa, Mfb oriented respectively toward the seal body axial inner and outer faces S2a, S2b. The circular sealing lip M is defined between an outer edge M1 of the circular sealing lip M that is connected to the inner surface IS of the body S2 and an inner edge M2 of the circular sealing lip M that is spaced radially inward from the outer edge M1 and that can also be inwardly axially offset in the first direction D1 relative to the outer edge M1. The inner edge M2 of the circular sealing lip M is adapted and configured to sealingly engage the outer surface TS of the shaft T to inhibit escape of oil, grease, or other lubricant from the bearing BX and inner housing region HR. The outer edge M1 of the circular lip M can be located adjacent the seal outer face S2b and, like the helical sealing lip L, the circular sealing lip M can be biased or offset axially inward toward the inner face S2a of the seal S body S2 (toward the bearing BX and housing inner region R) and away from the outer face S2b of the seal body such that the inner edge M2 of the circular sealing lip M is spaced axially inward in the direction D1 relative to the outer edge M1. As shown in FIG. 5, the circular sealing lip M thus defines an acute offset angle A′ between a third reference line Rf3 that intersects the outer and inner edges M1,M2 of the circular sealing lip M and the second reference line Rf2 that lies in the same plane as the third reference line Rf3 and that is coincident with or parallel with the seal axis SX. The acute offset angle A′ of the circular sealing lip M is less than 90 degrees and, for example can be less than 70 degrees or can be 60 degrees or less. In one non-limiting example, the acute offset angle A′ lies in the range of 65 degrees to 35 degrees, inclusive, or in the range of 60 degrees to 40 degrees, inclusive, such as 60 degrees or 55 degrees or 50 degrees, for example, and can be the same or different than the offset angle A of the helical sealing lip L. A lubricant chamber ML is defined between the outer axial end L2 of the helical sealing lip L and the circular sealing lip M. Alternatively, the circular sealing lip M can be non-offset such that the offset angle is equal to 0 degrees.

With reference again specifically to FIG. 1, a main advantage of the seal S is that when the seal S is operatively installed with its one or more helical sealing lips L sealingly engaged with the shaft outer surface TS and with its circular sealing lip M also sealingly engaged with the shaft outer surface TS, the helical sealing lip(s) L and the circular sealing lip M each maintain their inward offset or inward bias such that: (i) the inner edge EL2 of the helical sealing lip L is located axially inward in the direction D1 relative to the outer edge EL1 of the helical sealing lip L at any given circumferential location along the helical sealing lip L; and (ii) the inner edge M2 of the circular sealing lip M is located axially inward in the direction D1 relative to the outer edge M2 of the circular sealing lip M at every given circumferential location along the circular sealing lip M. When the seal S is operatively installed, the outer edges EL2, M2 are each deflected radially outward by the shaft outer surface TS with respect to the fee state of the sealing lips L, M but the sealing lips L, M do not invert or reverse their inward bias/offset even in the case where the seal S is pushed axially inward in the direction D1 about the shaft outer surface TS during the seal installation procedure, because the natural inwardly biased or offset state of the sealing lips L, M resists such inversion or reversal. Furthermore, the inward bias/inward offset of the sealing lips L, M has been found by the present inventors to make the sealing lips L, M resistant to being moved in the outward direction D2 opposite the inward direction D1 and resistant to being unseated by oil or other lubricant pressure build-up in the lubricant channel LC of the seal LC and/or in the lubricant chamber ML defined between the helical sealing lip L and the circular sealing lip M. Instead, due to the inward bias of the helical and circular sealing lips L, M, lubricant (oil) pressure in the lubricant channel LCS and chamber ML exerts a force on the helical and circular sealing lips L, M that urges the outer edge EL2 of the helical lip L and the outer edge M2 of the circular lip M radially inward toward the central axis SX of the seal and rotational axis TX of the shaft T which increases the sealing force exerted by the helical and circular sealing lips L, M on the shaft outer surface TS. In this sense, the inwardly biased sealing lips L, M are pressure activated because pressure exerted on the axially inner faces Lfa, MFa thereof increases the radially inward directed force exerted on the shaft outer surface TS by the sealing lips L, M.

In use of the seal S, the spiral or helical sealing lip L acts as an auger or pump when the shaft T rotates relative to the housing H in a first or operative angular direction about the axis of rotation TX and/or when the housing H rotates about the axis or rotation TX relative to the shaft T in a second angular direction that is opposite the first angular direction to inhibit loss of lubricant such as oil or grease and to actively pump the lubricant axially inward toward the bearing BX and internal region HR of the housing H. Simultaneously, the circular sealing lip M inhibits or prevents the escape of any lubricant from the lubricant chamber ML in the outward axial direction D2 opposite the first or inward axial direction D1 in the cases where lubricant has flowed into the lubricant chamber ML such as when oil flows into the lubricant chamber ML through the helical lubricant channel LC during periods when there is no relative rotation between the shaft T and housing H. The helical sealing lip L and the circular sealing lip M thus provide a seal S with a dual seal structure including the active pumping action of the helical sealing lip L and the passive sealing action of the circular seal M.

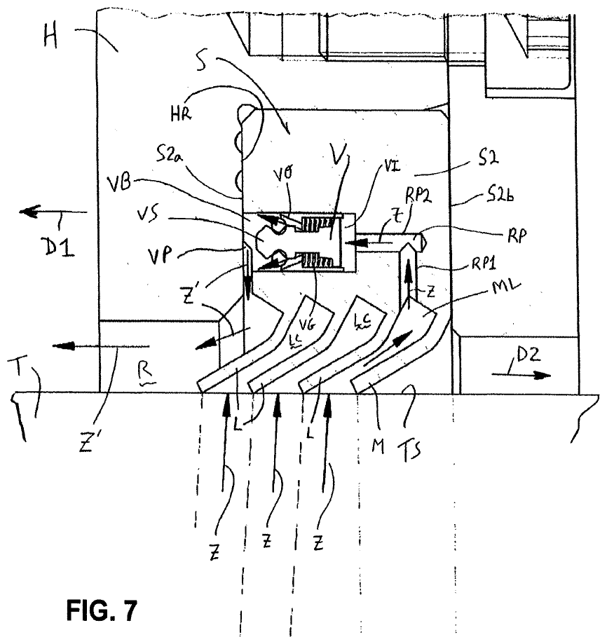

Referring to FIG. 7, when oil or another flowable lubricant is used, the oil or other lubricant can flow into and fully or partially fill the helical lubricant channel LC and/or the lubricant chamber ML. As noted above, the inward bias of the helical and circular sealing lips L, M allows them to resist a pressure “blow-out” in which the helical lip L and/or circular lip M are unseated and/or inverted/reversed in terms of their inward bias as would allow lubricant leakage in the outward direction D2 beyond the seal S. Because the wind turbine blades or other device(s) connected to the shaft T can sometimes cause the shaft to be back-driven and rotate in a second angular direction that is opposite its first or operative angular direction, the helical sealing lip L will under such conditions actively pump the oil or other lubricant in the outward direction D2 which can lead to a pressure build-up in the lubricant chamber ML, i.e., a pressure differential between a relatively lower oil pressure in the housing bearing region R as compared to a relatively higher oil pressure the lubricant chamber ML. Depending upon the size of the seal and the actual conditions, this pressure difference may lead to the above-described “blow-out” condition and oil leakage. To relieve this pressure difference, certain embodiments of the seal S can optionally comprise one or more pressure relief valves V connected to and/or defined by the seal body S2 as shown in FIGS. 1, 7, & 8. In one embodiment as shown in FIG. 1, a plurality of two or more pressure relief valves V are embedded in the seal body S2 and are circumferentially spaced about the seal axis SX and can be symmetrically arranged about the circumference of the seal body S2. These pressure relief valves V can be all the same or can include multiple different types within a single seal S.

With reference to the enlarged partial view of FIG. 7, each pressure relief valve V can be a one-way or check-valve device connected to and/or formed as part of the seal body S2 and including a valve inlet VI and a valve outlet VO located downstream from the valve inlet VI. The valve V can be a normally closed valve. In the illustrated embodiment, the valve includes a valve element such as a movable flap or an axially movable stem VS that is biased to a closed position by gravity or by a closing spring VG that can be coaxially positioned about or otherwise engaged with the valve stem VS or other movable valve element. The valve opens by movement of the valve stem VS or other valve element from its closed position to its opened position against any closing force exerted on the valve element by the spring VG or gravity or the like to allow oil lubricant flow in one direction from the valve inlet VI to the valve outlet VO when the fluid pressure differential across the valve element between the inlet and outlet VI, VO exceeds a select cracking pressure. In one non-limiting example, the cracking pressure is selected to be inclusively in the range of 1-to-5 pounds per square inch (psi) but any other suitable and desired cracking pressure can be used.

The seal body S2 can include a valve installation bore VB that opens in the inner axial face S2a (only one shown in FIG. 3) and in which the valve V is installed or located so that the valve outlet VO is in fluid communication with an open entrance VB1 of the bore VB that opens through the axial inner face S2a. The inner face S2a of the seal body S2 can also include a vent groove or vent passage VP (only partially shown in FIG. 3) located on or adjacent the axially inner face S2a of the body S2. The vent passage VP is in fluid communication with the valve outlet VO by way of the entrance VB1 of the valve bore VB. The vent passage VP can extend circumferentially and can also extend axially inward and communicates with the inner bearing region R of the housing H. The seal body S2 also includes a relief passage RP defined therein that fluidically connects the lubricant chamber ML to the valve inlet VI. As shown in the illustrated example, the relief passage RP includes a radial segment RP1 that connects with the lubricant chamber ML and includes an axial segment RP2 that connects with the radial segment RP1 and that also connects at its opposite end with the valve installation bore VB and the inlet VI of the valve V, but the relief passage can be otherwise configured. In operative use, oil as indicated by the arrows Z flows in the helical lubricant channel LC into the lubricant chamber ML due to the reverse pumping action of the seal S when the shaft T is back-driven (or for any other reason) and into the relief passage RP where it is blocked by the normally closed valve until the pressure of the oil Z at the valve inlet VI exceeds the cracking pressure at which time the valve V opens so that the oil can flow through the valve V from the inlet VI to the outlet VO and be vented into the housing inner region R via vent passage VP as indicated by the arrows Z′. The valve V returns to its normally closed state to block fluid flow in both directions under the force of the closing spring VG or in some designs under the force of gravity or a resilient biasing force of the material from which the seal body S2 is defined when sufficient oil is vented as shown at Z′ to reduce the pressure in the relief passage RP and lubricant chamber ML to a pressure that is less than the cracking pressure. The pressure relief valve V selectively communicates lubricating oil from the chamber ML located adjacent the second end Lb of the helically extending sealing lip L to the housing region R adjacent said first end La of the helically extending sealing lip L. In this manner, seal blow-out is prevented and the vented oil Z′ is contained in the housing region R as required to lubricate the bearing BX (FIG. 1).

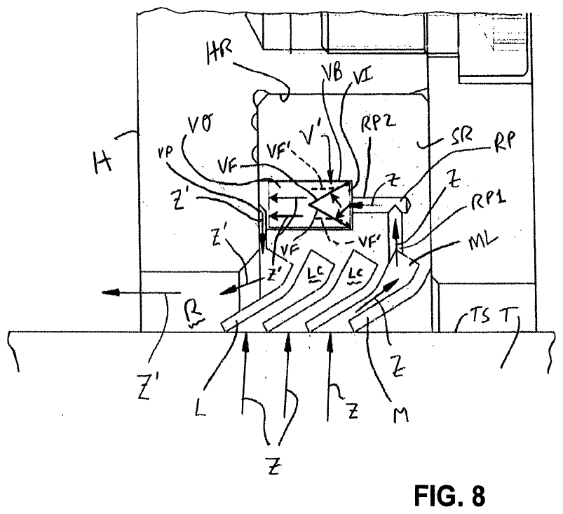

FIG. 8 shows an alternative valve design V′ in which the valve V′ comprises one or more resilient flaps VF that are normally closed to block fluid flow in either direction but that resiliently move (as shown in broken lines at VF′) to allow fluid flow from the valve inlet VI to the valve outlet VO when the fluid pressure in the relief passage RP at the valve inlet VI exceeds the cracking pressure. The resilient flaps VF can be provided as part of a separate valve element installed in the valve installation bore VB or the one or more flaps VF can each be defined as a one-piece polymeric structure with the seal body S2. In one example, the valve V′ is a duckbill valve or similar.

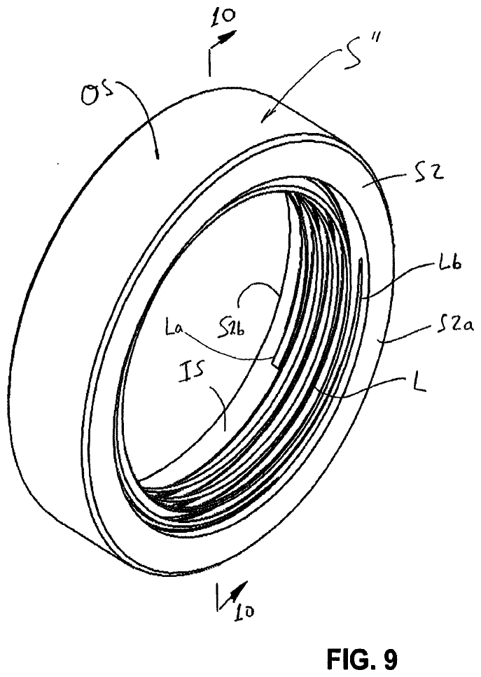

FIG. 9 is an isometric view of an alternative seal S″ and FIG. 10 is section view taken at 10-10 of FIG. 9. The seal S″ is identical to the seal S (or S′) but omits the circular or endless sealing lip M and/or can also omit the pressure relief valves V, V′.

The sealing lip L follows either a right-handed helical path (also referred to herein as right-handedness or a right-handed orientation or right-hand chirality) or a left-handed helical path (also referred to herein as left-handedness or a left-handed orientation or left-hand chirality) depending upon the specified direction of rotation of the shaft T for a given application so that the oil, grease, or other lubricant is actively pumped inwardly in the direction D1 for the normal or first operative rotational direction of the shaft T relative to the housing H (and/or housing H relative to the shaft T). The orientation or chirality of the helical sealing lip L is selected to ensure that the lubricant is pumped or urged in the inward direction D1 during normal operative relative rotation between the shaft T and housing H.

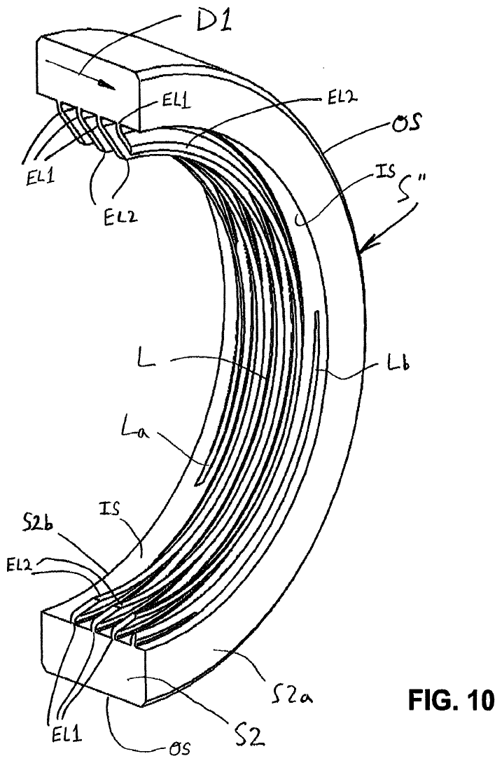

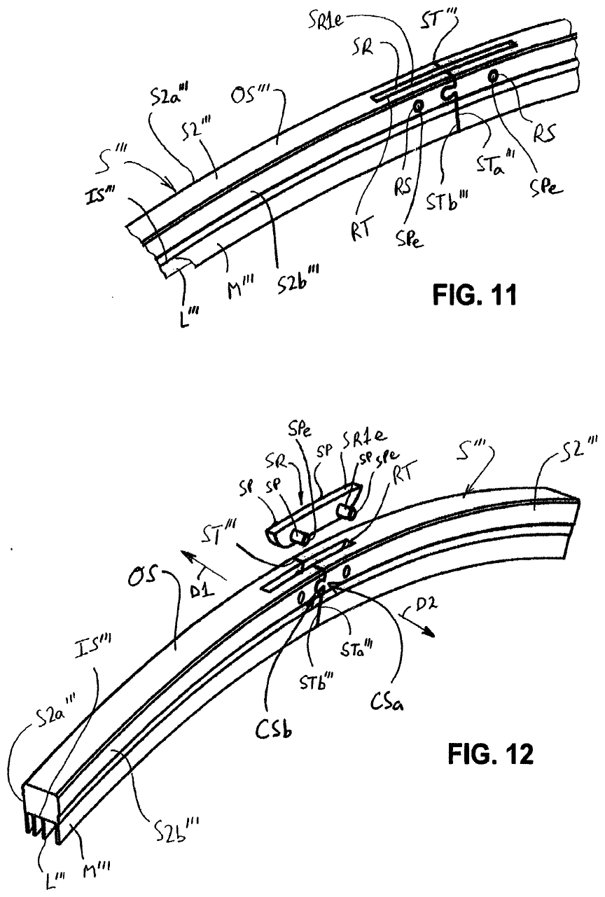

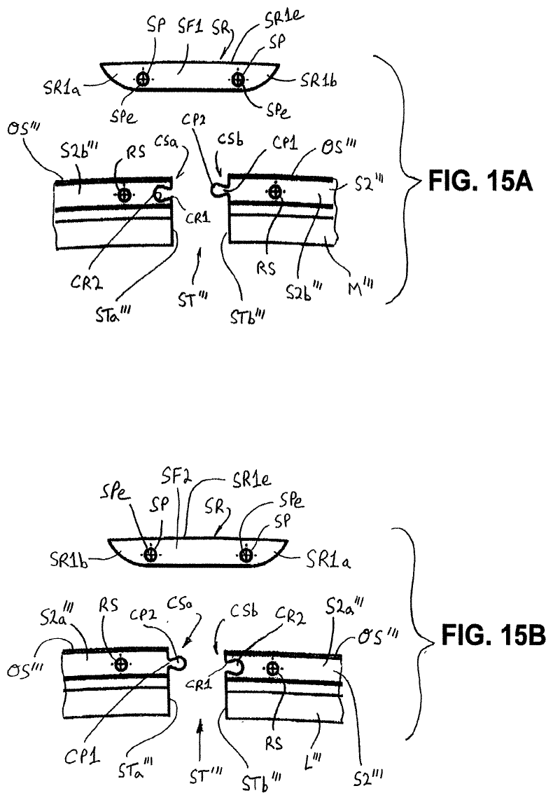

As noted above, in certain alternative variations, the seal S can include an axial split ST that allows the seal S to be installed around a shaft T when it is not possible or preferred to slide the seal S over an exposed end of the shaft T and, instead, the seal S must be split and wrapped around the shaft T, after which the split ST is re-closed for operative use of the seal S. FIG. 11 is a partial isometric view of a variation of a lubricant pumping seal S′″ provided in accordance with the present development including a reclosable split structure ST′″ in accordance with one aspect of the present development. Except as otherwise shown and/or described herein, the seal S′″ shown in FIG. 11 is identical to the seal S. The illustrated seal S′″ includes at least one helical lip L′″ and optionally also a circular lip M′″ corresponding respectively to the helical lip L and circular lip M described above in relation to the seal S. FIG. 12 shows a variation of the seal S′″ that is similar to FIG. 11 but shows the split retainer SR of the seal S′″ in an exploded configuration relative to the seal body S2′″, and also shows that, unlike the seal S′″ of FIG. 11, the helical lip L′″ and/or circular lip M′″ can be provided in an optional variation in which the helical lip L′″ and circular lip M′″ are not angled or biased axially inward as described above in relation to the seal S such that the offset angles A, A′ equals 0 degrees (also shown in FIGS. 14A & 14B), whereas the seal S′″ of FIG. 11 and FIGS. 15A,15B shows the seal variation in which the helical lip L′″ and circular lip M′″ of the seal S′″ are formed exactly as described above for the helical lip L and circular lip M of the seal S so as to be offset axially inwardly so as to define a nonzero offset angle A, A′. In another alternative embodiment, the lip L′″ can be circular or multiple circular lips L′″ are provided, in each case with or without the optional circular lip M′″.

The seal S′″ includes an axially split ST′″ that extends axially completely between and through the inner and outer axial faces S2a, S2b′″ and also extends radially completely between and through the inner and outer circumferentially extending surfaces IS′″, OS′″ so that the seal body S2′″ can be selectively manually spread apart, installed about the shaft T, and the opposite first and second faces STa′″, STb′″ of the split ST′″ re-closed so that the seal body S2′″ once again defines an operative annular shape with smooth uninterrupted inner and outer circumferential surfaces IS′″, OS′″ and uninterrupted inner and outer axial faces S2a′″, S2b′″. In the illustrated example, the split ST′″ can be defined along a non-planar or non-linear path such that the opposite first and second split faces STa′″, STb′″ comprise respective complementary first and second contoured structures CSa, CSb (see also FIGS. 14A-15B) that intimately mate and are engaged when the first and second split faces STa′″, STb′″ are abutted, but only in one position where the split faces STa′″, STb′″ are aligned in terms of their respective radial positions such that the inner and outer circumferential surfaces IS′″, OS′″ are each radially aligned across the split ST′″ so that when the first and second split faces STa′″, STb′″ are abutted, the inner and outer circumferential surfaces IS′″, OS′″ each extend along a circular path across the split ST′″. In this manner, the respective mating contoured structures CSa, CSb of the first and second split faces STa′″, STb′″ are configured to ensure proper alignment of the seal S′″ when it is operatively installed about a shaft T and the split ST′″ is re-closed.

With continuing reference to FIGS. 11-15B, the first and second contoured structures CSa, CSb can be structured to mate with an interlocking engagement when the first and second split faces STa′″, STb′″ are abutted prevent or at least inhibit circumferential separation or disengagement of the first and second split faces STa′″, STb′″ during operative use of the seal S′″. In the illustrated example, the first and second contoured structures CSa, CSb respectively comprise complementary mating female and male structures CR, CP. As shown, the first contoured surface structure CSa can comprise a recess CR and the second contoured surface structure CSb can comprise a projection CP that mates with and is closely received in the recess CR. The recess CR is formed to include a narrow entrance CR1 that opens in the first split face STa′″ and the recess CR is also formed to include an enlarged inner portion CR2 that communicates with the narrow entrance CR1. The projection CP is formed with a narrow neck CP1 that projects outwardly from the second split face STb′″ and that conformed and dimensioned to be closely received in the narrow entrance CR1 of the recess CR and the projection CP also includes enlarged end portion CP2 connected to and located at the outer end of the narrow neck CP1 that is closely received in the enlarged inner portion CR2 of the recess CR to prevent circumferential separation of the first and second split faces STa′″, STb′″. The recess and projection CR, CP can be formed to open through both or at least one of the inner and outer axial faces S2a′″, S2b′″ of the seal body S2′″ as shown such that the female and male structures CR, CP can be engaged/mated and/or disengaged/unmated with relative axial sliding or shear movement between the first and second split faces STa′″, STb′″ in the inward and/outward axial directions D1, D2.

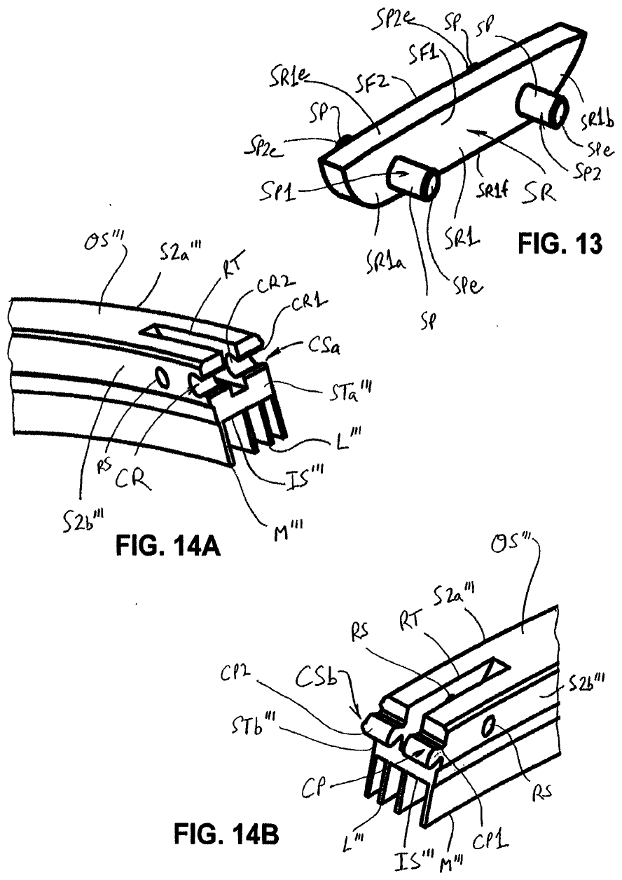

The seal S′″ can further comprise at least one optional seal retainer SR or multiple seal retainers SR, each of which is selectively releasably connected to the seal body S2″ in a location where the seal retainer SR circumferentially spans the split ST′″ and engages the seal body S2′″ on opposite sides of the split ST′″ to retain the first and second split faces STa′″, STb′″ in their mated, abutted position or configuration and to prevent separation of the first and second split faces STa′″, STb′″ and opening of the split ST′″. The seal retainer SR (shown by itself in FIG. 13) comprises a body SR1 that can be flat and that can be symmetrically formed so as to be equally installable in first and second orientations. The body SR1 comprises first and second opposite ends SR1a, SR1b and opposite first and second side faces SF1,SF2. Each end SR1a, SR1b comprises a at least one transverse projection SP that projects laterally outward from at least one and preferably both of the first and second side faces SF1,SF2 as shown herein. In the illustrated example, the at least one transverse projection SP is provided by first and second cylindrical studs SP1,SP2 that project respectively transversely outward from both the first and second side faces SF1,SF2 of the body SR1, but the transverse projections SP can have any other desired shape. The body SR1 and the projections SP can be provided by a single one-piece structure such as a one-piece molded, cast, machined, additively formed, and/or otherwise formed one-piece polymeric structure, although a multi-piece structure formed using other materials and/or methods can alternatively be used.

The seal body S2′″ comprises a slot RT or other recess for selectively receiving each seal retainer SR therein for operative installation of the seal retainer SR. The slot RT circumferentially spans the split ST′″. In the illustrated example of FIGS. 11-15B , the slot RT opens through the outer circumferential surface OS′″ and can be located axially midway or equidistant between the inner and outer axial faces S2a′″, S2b′″ and intersects both of the first and second split faces STa′″, STb′″. The slot RT is conformed and dimensioned to closely receive the body SR1 of the seal retainer SR such that an outer edge SR1e of the seal retainer body SR1 is flush with the circumferential outer surface OS′″ of the seal body S2′″ such that the outer edge SR1e of the seal retainer SR forms a smooth uninterrupted portion of the circumferential outer surface OS′″. The first and second opposite ends SR1a, SR1b of the seal retainer SR can be curved as shown such that the outer edge SR1e is longer than an opposite inner edge SR1f and the slot RT correspondingly formed to facilitate installation of the seal retainer SR.

The seal body S2′″ further comprises at least first and second transverse recesses RS that intersect the slot RT on opposite first and second circumferential sides of the split ST′″ and that are each adapted to receive and retain one of the transverse projections SP. In the illustrated example, the first and second recesses RS each comprises a cross-bore that extends between and through the opposite inner and outer axial faces S2a′″, S2b′″ of the seal body S2′″ and that intersects the slot RT. The first and second cylindrical studs SP1,SP2 or other transverse projections SP of the seal retainer SR can be closely received in the corresponding cross-bore CB when the seal retainer SR is operatively installed in the slot RT. The transverse projections SP of the seal retainer SR can each include opposite outer ends SPe, SPe that lie flush with the inner and outer axial faces S2a′″, S2b′″ of the body S2′″ when operatively installed.

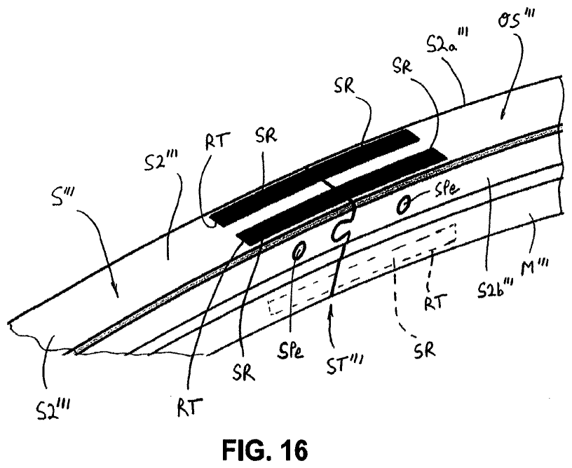

FIG. 16 shows another alternative variations in which the seal body S2″ of any of the foregoing variations comprises multiple seal retainer slots such as two or more seal retainer slots RT (see the illustrated first and second seal retainer slots RT) and the seal S2″ comprises a corresponding number of seal retainers SR (in this example first and second seal retainers SR) that are operatively received respectively in the first and second seal retainer slots RT. In another alternative variation, one or more seal retainer slots RT can alternatively be defined in and open through the inner axial face S2a′″ and/or the outer axial face S2b′″ (as shown in broken lines) to receive a seal retainer SR therein.

In accordance with one aspect, the seal S comprising both a helical sealing lip and a circular sealing lip. In another variation, either the helical sealing lip or the circular sealing lip or both the helical sealing lip and circular sealing lip of the seal are inwardly angled or inwardly biased such that a radially inner portion thereof is located axially inward as compared to a radially outer portion thereof, or the helical sealing lip or the circular sealing lip or both the helical sealing lip and circular sealing lip of the seal can be configured such that a radially inner portion of the lip is aligned with a radially outer portion thereof in terms in terms of their axial positions so that the lip is oriented normal to the central axis of the seal. The seal can include at least one inwardly biased helical sealing lip and a circular sealing lip. The seal circular sealing lip can optionally be inwardly biased. A seal according to another variation can include at least one sealing lip and one or more pressure relief valves, and such seal can also comprise an axial split and a seal retainer that recloses the axial split. A seal according to another variation can include at least one sealing lip and an axial split comprising first and second split faces that are abutted, wherein the first and second split faces comprise complementary mating structures that are engaged when the first and second split faces are abutted and that inhibit circumferential separation of the first and second split faces. A split seal in any variation can include seal retainer slot formed in a body of the seal and spanning an axial split, wherein the seal further includes a seal retainer that is selectively located in the seal retainer slot to retain the first and second split faces abutted with each other. The seal retainer can comprise a body with first and second transverse projections located on opposite first and second ends of the body, and the seal retainer slot can comprise first and second recesses for respectively receiving the first and second transverse projections.

The development has been described with reference to preferred embodiments. Modifications and alterations will occur to those of ordinary skill in the art to which the invention pertains, and it is intended that the claims be construed as encompassing all such modifications and alterations to the maximum possible extent while preserving the validity of the claims.

1. A seal comprising:
an annular body including an outer circumferential surface that defines an outside diameter, an inner circumferential surface that defines a central opening about a seal axis, an inner axial face, and an outer axial face, wherein said inner and outer axial faces extend between the inner and outer circumferential surfaces on inner and outer axial sides of the annular body;
at least one continuous, uninterrupted, flexible helically extending sealing lip comprising opposite first and second ends and comprising an outer edge connected to the inner circumferential surface of the body and an inner edge spaced inwardly toward the seal axis relative to the outer edge, wherein said inner edge of said helically extending sealing lip is axially offset in a first axial direction as compared to the outer edge of the helically extending sealing lip.

2. The seal as set forth in claim 1, further comprising a circular sealing lip located adjacent the second end of the helically extending sealing lip.

3. The seal as set forth in claim 2, further comprising at least one pressure relief valve connected to the body, said valve comprising: (i) a valve inlet in fluid communication with a lubricant chamber defined between the circular sealing lip and the helically extending sealing lip; and (ii) a valve outlet.

4. The seal as set forth in claim 3, wherein said valve is normally closed and opens in response to a select fluid pressure at said valve inlet.

5. The seal as set forth in claim 4, wherein said valve outlet is in fluid communication with a vent passage located adjacent said axial inner face of said seal body.

6. The seal as set forth in claim 5, wherein said seal body comprises a valve bore defined therein and including a valve bore entrance that opens in said axial inner face, wherein said valve is located in said valve bore with said valve outlet in fluid communication with said valve bore entrance, and wherein said vent passage is in fluid communication with said valve bore entrance.

7. The seal as set forth in claim 6, wherein the seal body comprises an axial split that extends between and through the inner and outer axial faces and that extends between and through the inner and outer circumferential surfaces, wherein said split comprises first and second split faces that are abutted.

8. The seal as set forth in claim 7, wherein the first and second split faces respectively comprise first and second complementary mating contoured structures that are engaged when the first and second split faces are abutted and that inhibit circumferential separation of the first and second split faces.

9. The seal as set forth in claim 8, wherein the outer circumferential surface extends smoothly and uninterrupted across said split when said first and second complementary mating contoured structures are engaged.

10. The seal as set forth in claim 9, wherein said first and second complementary mating contoured structures are engaged and disengaged only by relative sliding movement along said seal axis.

11. The seal as set forth in claim 7, further comprising a seal retainer slot formed in the body of the seal and circumferentially spanning the axial split, said seal further comprising a seal retainer that is selectively operatively installed in the seal retainer slot to retain the first and second split faces abutted with each other.

12. The seal as set forth in claim 11, wherein the seal retainer comprises a body with first and second transverse projections located on opposite first and second ends of the body, and wherein the seal retainer slot comprises first and second recesses for respectively receiving the first and second transverse projections.

13. The seal as set forth in claim 11, wherein the seal retainer slot is formed in the outer circumferential surface of the seal body and the seal retainer comprises an outer edge that lies flush with the outer circumferential surface of the seal body when the seal retainer is operatively installed in the seal retainer slot.

14. The seal as set forth in claim 1, wherein the seal body comprises an axial split that extends between and through the inner and outer axial faces and that extends between and through the inner and outer circumferential surfaces, wherein said split comprises first and second split faces that are abutted.

15. The seal as set forth in claim 14, wherein the first and second split faces respectively comprise first and second complementary mating contoured structures that are engaged when the first and second split faces are abutted and that inhibit circumferential separation of the first and second split faces.

16. The seal as set forth in claim 15, wherein the outer circumferential surface extends smoothly and uninterrupted across said split when said first and second complementary mating contoured structures are engaged.

17. The seal as set forth in claim 16, wherein said first and second complementary mating contoured structures are engaged and disengaged only by relative sliding movement along said seal axis.

18. The seal as set forth in claim 14, further comprising a seal retainer slot formed in the body of the seal and circumferentially spanning the axial split, said seal further comprising a seal retainer that is selectively located in the seal retainer slot to retain the first and second split faces abutted with each other.

19. The seal as set forth in claim 18, wherein the seal retainer slot is formed in the outer circumferential surface of the seal body and the seal retainer comprises an outer edge that lies flush with the outer circumferential surface of the seal body when the seal retainer is operatively installed in the seal retainer slot.

20. The seal as set forth in claim 19, wherein the seal retainer comprises a body with first and second transverse projections located on opposite first and second ends of the body, and wherein the seal retainer slot comprises first and second recesses for respectively receiving the first and second transverse projections.

21.-28. (canceled)
